(19) United States
(12) Patent Application Publication
(10) Pub. No.: US 2020/0142770 A1
(43) Pub. Date: May 7, 2020

(54) INTERNET OF THINGS APPLIANCE DIAGNOSTICS

(71) Applicant: INTERNATIONAL BUSINESS MACHINES CORPORATION, ARMONK, NY (US)

(72) Inventors: Chih-Hsiung Liu, Taipei (TW); Shaw-Ben Shi, Austin, TX (US); Xinlin Wang, Irvine, CA (US); Norman Kung, Taipei (TW); Ci-Wei Lan, Keelung (TW)

(21) Appl. No.: 16/179,028

(22) Filed: Nov. 2, 2018

(51) Int. Cl. G06F 11/07; G06F 9/54

(52) U.S. Cl. CPC G06F 11/0793; G06F 11/0709; H04W 84/12; G06F 9/54; G06F 11/0784; G06F 11/079

(57) ABSTRACT

A computer-implemented method for diagnosing one or more malfunctions of one or more machines within a network. The method monitors the one or more machines within the network and identifies one or more machines that is broadcasting a malfunction message. The method further accesses a product manual for the identified one or more machines and diagnoses the one or more malfunctions of the identified one or more machines, based on a matching description of the malfunction message within the product manual. The method may further perform a diagnostic data collection on the identified one or more machines that is broadcasting a malfunction message and identify a fixing procedure based on the diagnosed one or more malfunctions. The method further communicates the fixing procedure, for the identified one or more machines that is broadcasting the malfunction message, to a user.

### BACKGROUND

The present disclosure relates generally to the field of cognitive computing and more particularly to data processing and diagnosis of electronic devices within an Internet of Things (IoT) network.

Home appliances do not last forever, and more often than not, they experience malfunctions that cost people time and money to diagnose and repair. Additionally, home appliance problem diagnostics can be a tedious process, especially for people unfamiliar with technical/mechanical operations and semantics. Typically, the manuals that come along with an appliance have limited help for diagnosing the problem. For example, the appliance manual is unlikely to cover all potential issues, it may not be up-to-date, and some appliance issues cannot be identified without inspecting the internal state of the appliance.

### BRIEF SUMMARY

Embodiments of the present invention disclose a method, a computer program product, and a system.

A method, according to an embodiment of the invention, in a data processing system including a processor and a memory, for diagnosing one or more malfunctions of one or more machines within a network. The method includes monitoring the one or more machines within the network and identifying one or more machines that are broadcasting a malfunction message. The method further includes accessing a product manual for the identified one or more machines and diagnosing the one or more malfunctions of the identified one or more machines, based on a matching description of the malfunction message within the product manual. The method further includes identifying a fixing procedure based on the diagnosed one or more malfunctions and communicating the fixing procedure, for the identified one or more machines that is broadcasting the malfunction message, to a user.

A computer program product, according to an embodiment of the invention, includes a non-transitory tangible storage device having program code embodied therewith. The program code is executable by a processor of a computer to perform a method. The method includes monitoring the one or more machines within the network and identifying one or more machines that are broadcasting a malfunction message. The method further includes accessing a product manual for the identified one or more machines and diagnosing the one or more malfunctions of the identified one or more machines, based on a matching description of the malfunction message within the product manual. The method further includes identifying a fixing procedure based on the diagnosed one or more malfunctions and communicating the fixing procedure, for the identified one or more machines that is broadcasting the malfunction message, to a user.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method includes monitoring the one or more machines within the network and identifying one or more machines that are broadcasting a malfunction message. The method further includes accessing a product manual for the identified one or more machines and diagnosing the one or more malfunctions of the identified one or more machines, based on a matching description of the malfunction message within the product manual. The method further includes identifying a fixing procedure based on the diagnosed one or more malfunctions and communicating the fixing procedure, for the identified one or more machines that is broadcasting the malfunction message, to a user.

### BRIEF DESCRIPTION OF THE DRAWINGS

FIG. 1 illustrates an appliance diagnostic computing environment, in accordance with an embodiment of the present invention.

FIG. 2 is a flowchart illustrating the operation of appliance diagnostic program of FIG. 1, in accordance with an embodiment of the present invention.

FIGS. 3A and 3B illustrate a use case of appliance diagnostic program of FIG. 1, in accordance with an embodiment of the present invention.

FIG. 4 is a diagram graphically illustrating the hardware components of appliance diagnostic computing environment of FIG. 1, in accordance with an embodiment of the present invention.

FIG. 5 depicts a cloud computing environment, in accordance with an embodiment of the present invention.

FIG. 6 depicts abstraction model layers of the illustrative cloud computing environment of FIG. 5, in accordance with an embodiment of the present invention.

### DETAILED DESCRIPTION

As discussed above, home appliance problem diagnostics can be a tedious process, even if there is a manual that comes along with the appliance to help a user examine a device step-wise. Oftentimes, technical/mechanical documentation can make matters more confusing to an end-user, especially if the end-user is not tech-savvy. Furthermore, appliance manuals may be updated, redacted, and no longer applicable to a current appliance. This problem demands that an end-user do their own background check on the appliance, whether it be online through the appliance manufacturer's website, or via calling the manufacturer directly.

Currently, there is no solution that removes the end-user from diagnosing a home appliance's malfunction, or issue. The present invention improves upon the current technology by not requiring human intervention, by performing a thorough array of diagnostics on an appliance, and by accessing an appliance's more detailed, and up-to-date, product manual that may be stored on the cloud.

The present invention discloses a method to diagnose one or more malfunctions of one or more appliances, without the need of an end-user to either recognize that there is a malfunction with one or more appliances, or the need of the end-user to perform any diagnostic data collecting. The discovery of a malfunction, as well as the performance of diagnostic data collection, for an appliance may be performed automatically by a home robot within an IoT network.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

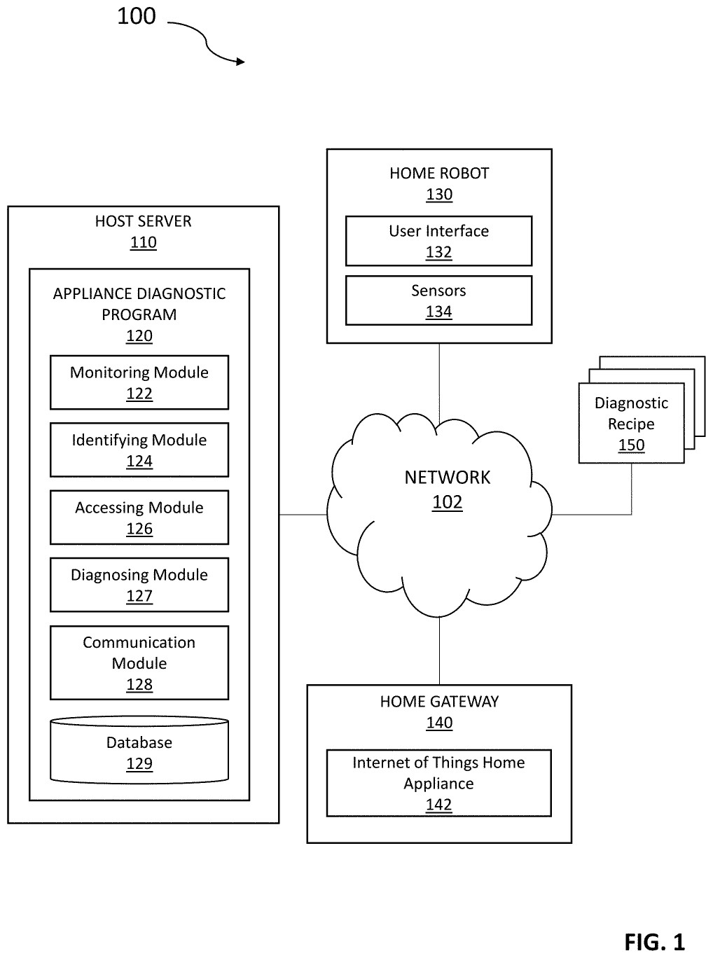

FIG. 1 illustrates appliance diagnostic computing environment 100, in accordance with an embodiment of the present invention. Appliance diagnostic computing environment 100 includes host server 110, home robot 130, home gateway 140, and diagnostic recipe (DR) 150 all connected via network 102. The setup in FIG. 1 represents an example embodiment configuration for the present invention, and is not limited to the depicted setup in order to derive benefit from the present invention.

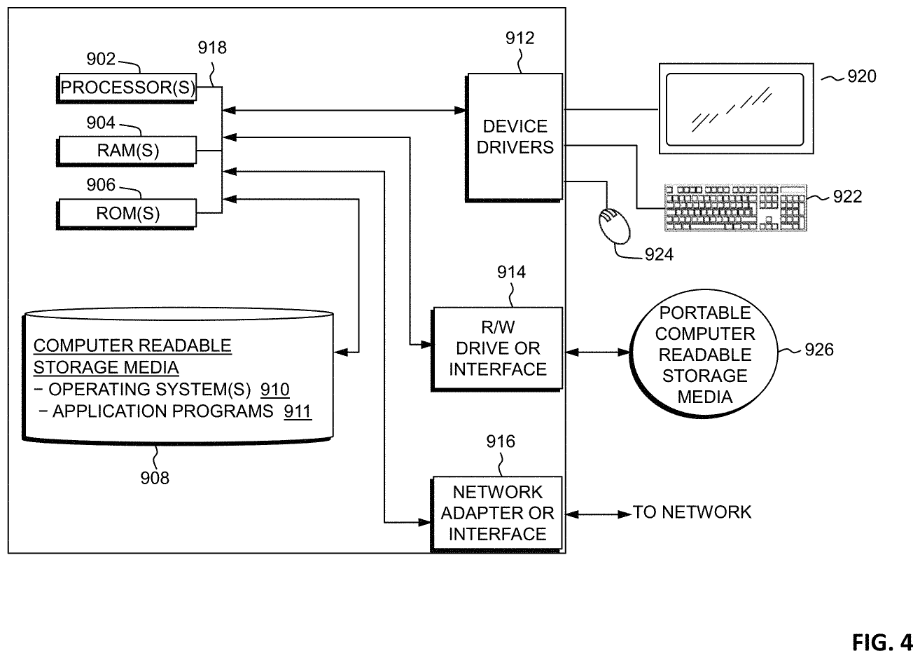

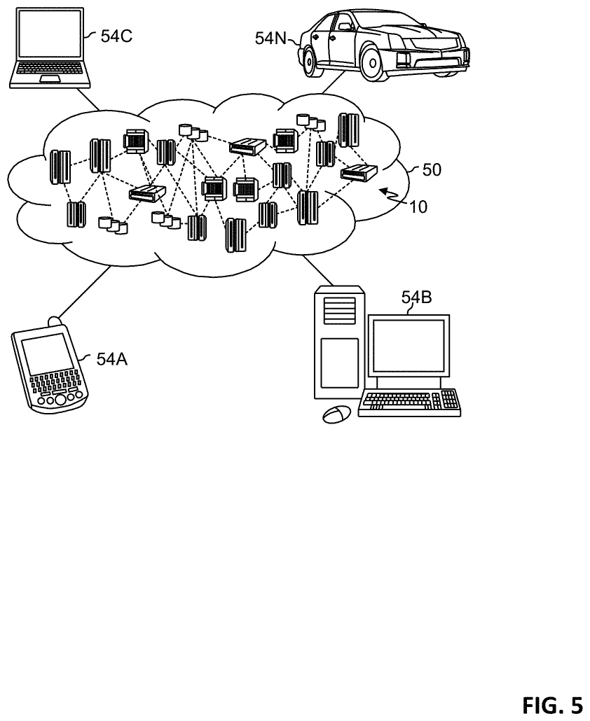

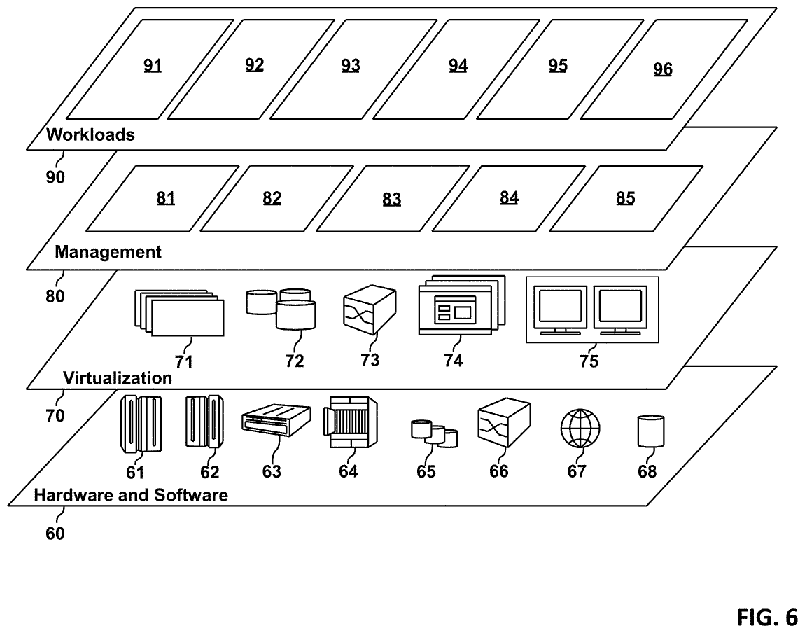

In the example embodiment, host server 110 includes appliance diagnostic program 120. In various embodiments, host server 110 may be a laptop computer, tablet computer, netbook computer, personal computer (PC), a desktop computer, a personal digital assistant (PDA), a smart phone, a server, or any programmable electronic device capable of communicating with home robot 130, home gateway 140, and DR 150 via network 102. Host server 110 may include internal and external hardware components, as depicted and described in further detail below with reference to FIG. 4. In other embodiments, host server 110 may be implemented in a cloud computing environment, as described in relation to FIGS. 5 and 6, herein. Host server 110 may also have wireless connectivity capabilities allowing host server 110 to communicate with home robot 130, home gateway 140, DR 150, and other computers or servers over network 102.

With continued reference to FIG. 1, home robot 130 contains user interface 132 and sensors 134. In various embodiments, home robot 130 may be a type of service robot (e.g., a domestic robot), an autonomous robot, a roving mechanical device, a laptop computer, tablet computer, netbook computer, personal computer (PC), a desktop computer, a personal digital assistant (PDA), a wearable device, a smart phone, or any programmable electronic device capable of communicating with host server 110, home gateway 140, and DR 150 via network 102. Home robot 130 may include internal and external hardware components, as depicted and described in further detail below with reference to FIG. 4. In other embodiments, home robot 130 may be implemented in a cloud computing environment, as described in relation to FIGS. 5 and 6, herein. Home robot 130 may also have wireless connectivity capabilities allowing home robot 130 to communicate with host server 110, home gateway 140, DR 150, and other computers or servers over network 102.

In exemplary embodiments, home robot 130 is capable of monitoring Internet of Things (IoT) home appliances 142 (e.g., by means of registered product IDs for each IoT home appliance 142), and alerts that are published, or broadcasted into home gateway 140 network. In various embodiments, the published messages, or alerts, contain the information needed for home robot 130 to download the appropriate diagnostic recipe 150 (e.g., URL, authorization keys) from a website or the cloud. Based on the downloaded DR 150, home robot 130 uses edge analytic models and preconfigured actions to identify the root cause of the IoT home appliance 142 malfunction or alert.

In exemplary embodiments, home robot 130 includes user interface 132, which may be a computer program that allows a user to interact with home robot 130 and other connected devices via network 102. For example, user interface 132 may be a graphical user interface (GUI). In addition to comprising a computer program, user interface 132 may be connectively coupled to hardware components, such as those depicted in FIG. 4, for receiving user input. In an exemplary embodiment, user interface 132 may be a web browser, however in other embodiments user interface 132 may be a different program capable of receiving user interaction and communicating with other devices.

In exemplary embodiments, home robot 130 includes sensors 134, which may be an electronic hardware component, module, or subsystem capable of sensing objects around itself, environmental conditions, and its relative position. In exemplary embodiments, sensors 134 may also be capable of detecting an operating status, a malfunction issue, and performing preliminary diagnostic measures for a home appliance, such as IoT home appliance 142, and sending the detection data to other electronics (e.g., a computer processor), components (e.g., database 129), or programs (e.g., appliance diagnostic program 120) within a system such as appliance diagnostic computing environment 100.

Sensors 134, in exemplary embodiments, may be located within home robot 130 and may be a global positioning system (GPS), software application, proximity sensor, camera, microphone, light sensor, infrared sensor, weight sensor, temperature sensor, tactile sensor, motion detector, optical character recognition (OCR) sensor, occupancy sensor, heat sensor, analog sensor (e.g., potentiometers, force-sensing resistors), radar, radio frequency sensor, video camera, digital camera, Internet of Things (IoT) sensors, lasers, gyroscopes, accelerometers, structured light systems, sound sensors, actuators, and other devices used for measuring an environment or current state of an electronic device, such as IoT home appliance 142.

In exemplary embodiments, the data collected from sensors 134 may be useful in assisting appliance diagnostic program 120 to diagnose an IoT home appliance 142 connected to home gateway 140. In alternative embodiments, appliance diagnostic computing environment 100 may include any other systems and methods for collecting and utilizing IoT home appliance 142 data within an IoT system, known to one of ordinary skill in the art, to help in diagnosing a malfunction with the IoT home appliance 142.

In exemplary embodiments, sensors 134 are capable of continuously monitoring, collecting, and saving collected data on a local storage database, or sending the collected data to appliance diagnostic program 120 for analysis. In alternative embodiments, sensors 134 may be capable of detecting, communicating, pairing, or syncing with IoT home appliance 142, thus creating opportunities for more direct integration of the physical world into computer-based systems, and resulting in improved efficiency, accuracy, and economic benefit in addition to reduced human intervention.

With continued reference to FIG. 1, home gateway 140 includes Internet of Things home appliance 142. In various embodiments, home gateway 140 may be a laptop computer, tablet computer, netbook computer, personal computer (PC), a desktop computer, a personal digital assistant (PDA), a wearable device, a smart phone, or any programmable electronic device capable of communicating with host server 110, home robot 130, and DR 150 via network 102. Home gateway 140 may include internal and external hardware components, as depicted and described in further detail below with reference to FIG. 4. In other embodiments, home gateway 140 may be implemented in a cloud computing environment, as described in relation to FIGS. 5 and 6, herein. Home gateway 140 may also have wireless connectivity capabilities allowing it to communicate with host server 110, home robot 130, DR 150, and other computers or servers over network 102.

In exemplary embodiments, home gateway 140 provides a basic messaging infrastructure for one or more IoT home appliances 142. Each IoT home appliance 142 registers the associated appliance product ID with home gateway 140 during boot up (e.g., broadcasts its product ID). Home robot 130 may be capable of subscribing all of the IoT home appliances 142 within a certain range (e.g., in living room, kitchen, and so forth). Home gateway 140, in exemplary embodiments, allows IoT home appliance 142 to communicate with home robot 130 without knowing the underlying network configuration details.

In exemplary embodiments, IoT home appliance 142 may include typical appliances found in a home (e.g., stove, oven, refrigerator, blender, hot plate, toaster, iron, water heater), consumer electronics (e.g., television, stereo, computer, alarm system), and any other electronic devices found in a home or office.

In exemplary embodiments, each IoT home appliance 142 may be capable of broadcasting (i.e., publishing) the associated appliance product ID and associated troubleshooting information (e.g., URL for IoT home appliance 142 product manual or DR 150). Besides basic appliance function, IoT home appliance 142 may be capable of providing a set of troubleshooting APIs that allows home robot 130 to perform a detailed diagnosis of what is happening in the IoT home appliance 142, or trigger a specific action from the IoT home appliance 142 (e.g., turn off, turn on, run motor faster, turn down temperature, turn on light, and so forth).

In exemplary embodiments, diagnostic recipe (DR) 150 may include a sequence of actions and related edge analytic models for each associated IoT home appliance 142 that allows home robot 130 to perform a diagnosis on behalf of the IoT home appliance 142 manufacturer. For example, diagnostic recipes 150 may be product manuals (e.g., URL to a product manual or DR 150), located on the world wide web or in the cloud, for each respective IoT home appliance 142. Having the DR 150 for each IoT home appliance 142 easily accessible via the cloud makes it easy for a device manufacturer to update the steps in real time, together with any updates and/or recalls, and make them readily available to home robot 130 and appliance diagnostic program 120.

With continued reference to FIG. 1, appliance diagnostic program 120, in an exemplary embodiment, may be a computer application on host server 110 that contains instruction sets, executable by a processor. The instruction sets may be described using a set of functional modules. In exemplary embodiments, appliance diagnostic program 120 may receive input from home robot 130, home gateway 140, and DR 150 over network 102. In alternative embodiments, appliance diagnostic program 120 may be a computer application executed on home robot 130, or as a standalone program on a separate electronic device.

With continued reference to FIG. 1, the functional modules of appliance diagnostic program 120 include monitoring module 122, identifying module 124, accessing module 126, diagnosing module 127, communication module 128, and database 129.

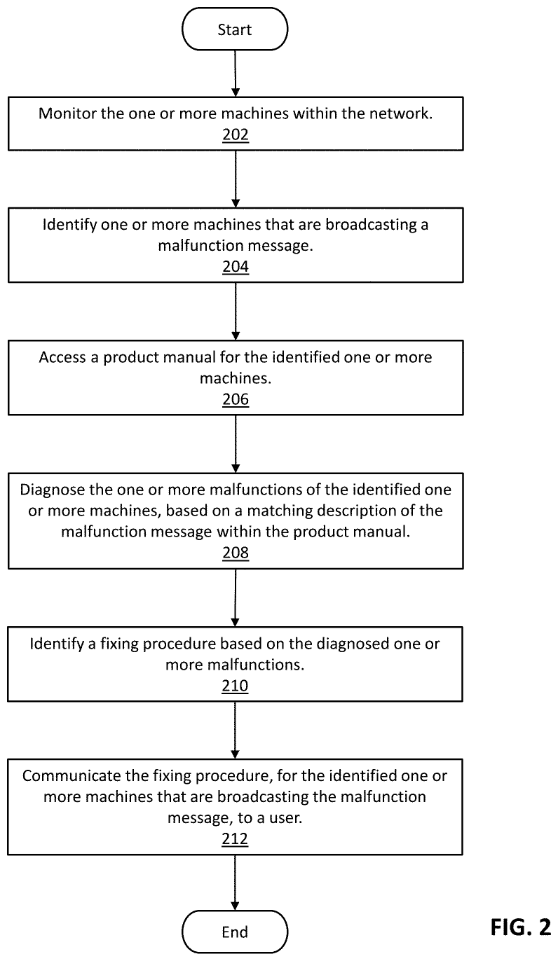

FIG. 2 is a flowchart illustrating the operation of appliance diagnostic program 120 of FIG. 1, in accordance with embodiments of the present invention.

With reference to FIGS. 1 and 2, monitoring module 122 includes a set of programming instructions in appliance diagnostic program 120, to monitor one or more machines, such as IoT home appliance 142, within network 102 (step 202). The set of programming instructions is executable by a processor.

In exemplary embodiments, monitoring module 122 continuously monitors the network of devices, included within home gateway 140, for any malfunction, irregular activity, or received alerts from one or more IoT home appliances 142.

With continued reference to FIGS. 1 and 2, identifying module 124 includes a set of programming instructions, in appliance diagnostic program 120, to identify one or more machines that is broadcasting a malfunction message (step 204). The set of programming instructions is executable by a processor.

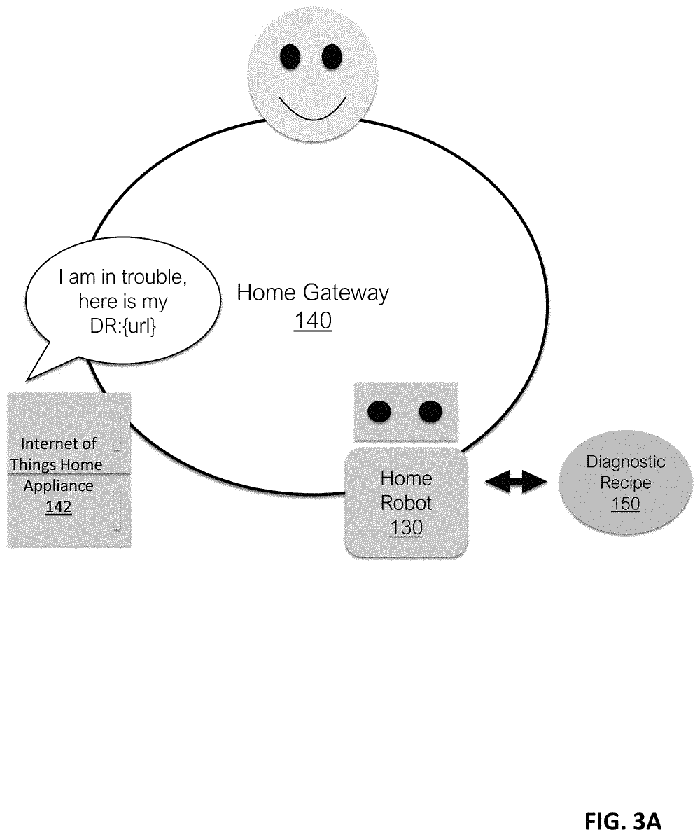

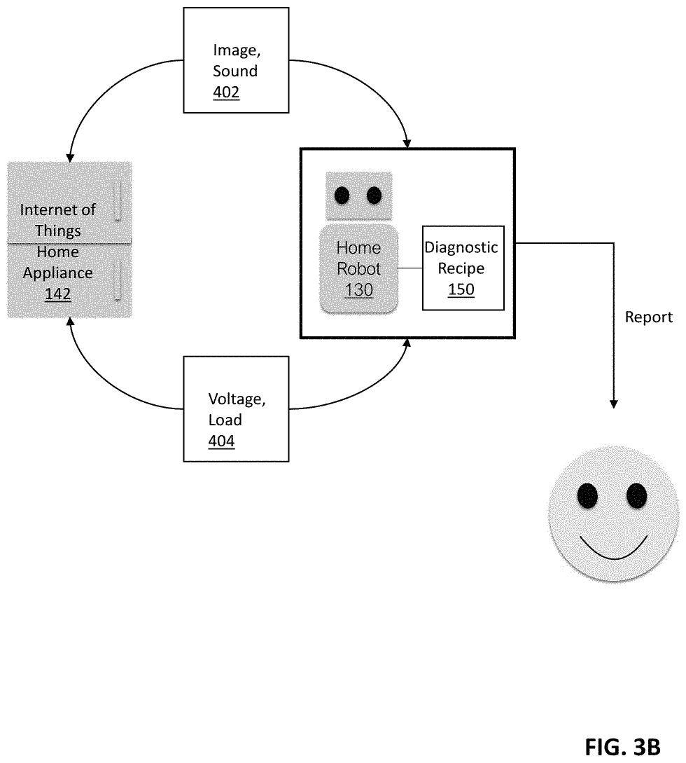

FIGS. 3A and 3B illustrate a use case of appliance diagnostic program 120 of FIG. 1, in accordance with an embodiment of the present invention.

With reference to FIG. 3A and an illustrative example, Billy has an IoT-connected home network. Billy's refrigerator has basic IoT network abilities as well as an application programming interface (API) that can provide protocol to instruct the refrigerator to provide information (e.g., manufacturer's specifications, etc.) or execute some processes (e.g., turn off, turn on, lower cooling temperature, etc.). Home robot 130 has the ability of accessing the refrigerator API. Monitoring module 122 receives an alert from home gateway 140, indicating that one of the IoT home appliances 142 (Billy's smart refrigerator) is suffering a malfunction and is in need of attention. Identifying module 124 identifies that the refrigerator is the IoT home appliance 142 that has broadcasted the alert over Billy's home network, together with the DR URL for the refrigerator.

With continued reference to FIGS. 1 and 2, accessing module 126 includes a set of programming instructions in appliance diagnostic program 120, to access a product manual for the identified one or more machines, such as IoT home appliance 142 (step 206). The set of programming instructions is executable by a processor.

With reference to FIG. 3B and the illustrative example above, accessing module 126 accesses the cloud server for Billy's refrigerator, based on the product ID and the URL received from the refrigerator. Home robot 130 downloads the most recent DR 150 for Billy's refrigerator and begins collecting diagnostic data based on DR 150. Home robot 130 is equipped with a camera, a microphone, and a speaker in order to perform diagnostic tests on the refrigerator if needed, such as obtaining images, sounds 402, and voltage, load 404 of the refrigerator.

With continued reference to FIGS. 1 and 2, diagnosing module 127 includes a set of programming instructions in appliance diagnostic program 120, to diagnose the one or more malfunctions of the identified one or more machines, based on a matching description of the malfunction message within the product manual (step 208). The set of programming instructions is executable by a processor.

In exemplary embodiments, diagnosing module 127 may need to perform a diagnostic data collection on the identified one or more machines that is broadcasting a malfunction message. The diagnostic data collection may include at least one of the following interactions between home robot 130 and the IoT home appliance 142: vision data collected via a camera, hearing data collected via a microphone, conversation data collected via a speaker, and communication data collected via wireless fidelity (WiFi) networking.

In exemplary embodiments, diagnosing module 127 may be capable of utilizing an API to perform the diagnostic data collection on the one or more machines (i.e., IoT home appliance 142) that is broadcasting the malfunction message, or alert.

With continued reference to FIG. 3B and the illustrative example above, after accessing the refrigerator's DR 150, diagnosing module 127 begins collecting the information needed to evaluate the malfunction of the refrigerator. Using its built-in camera, home robot 130 takes pictures of the plug and shell of the refrigerator. Additionally, home robot 130 is capable of using the refrigerator's API to turn the refrigerator on and to record its sound during the turning on process. Home robot 130 is further capable of using the refrigerator's API to order the refrigerator to perform a specific function, such as executing the ice-cube making part of the freezer and recording the sound during this process. Further, home robot 130 is capable of obtaining the voltage and the load of the refrigerator's motor.

In alternative embodiments, diagnosing module 127 may further be capable of utilizing a microphone and a speaker to interact with a user to collect additional information. For example, diagnosing module 127 may use a microphone to collect audio data from a user. The audio data file may then be processed via a natural language processing pipeline in order to detect user-described responses to questions posed by diagnosing module 127.

Referring back to FIG. 3B and the illustrative example above, home robot 130 may interact with Billy to collect deeper information about the refrigerator such as the frequency of the buzzing sound, any recent collisions with the refrigerator, and any additional information that diagnosing module 127 is unable to obtain by performing an initial diagnostic data collection solely with the IoT home appliance 142.

With continued reference to FIGS. 1 and 2, identifying module 124 includes a set of programming instructions in appliance diagnostic program 120, to identify a fixing procedure based on the diagnosed one or more malfunctions (step 210). The set of programming instructions is executable by a processor.

In exemplary embodiments, communication module 128 includes a set of programming instructions in appliance diagnostic program 120, to communicate the fixing procedure, for the identified one or more machines (i.e., IoT home appliance 142) that is broadcasting the malfunction message, to a user (step 212). The set of programming instructions is executable by a processor.

In exemplary embodiments, communication module 128 may be capable of transmitting a diagnostic report to the user that indicates one or more reasons for the malfunction message of the one or more machines, and sending a proposed repair form to the user that indicates action required to repair the one or more malfunctions. In various embodiments, the diagnostic report may be sent to the user via a text message, an e-mail, or in any other form known to one of ordinary skill in the art.

In alternative embodiments, communication module 128 may be capable of contacting a repair service to repair the one or more malfunctions of the identified one or more machines, based on the diagnostic report and the proposed repair form.

With continued reference to FIG. 3B and the illustrative example above, after completing its diagnostic data collection, communication module 128 sends a diagnostic report to Billy which indicates the probable reason for the refrigerator's malfunction. In this case, the reason for the refrigerator's malfunction was due to a foreign matter getting stuck in the motor. Along with the diagnostic report, communication module 128 may send Billy a repair form which includes all of the diagnostics performed by home robot 130, together with the detected results, and asks Billy if he needs home robot 130 to make a reservation with a local appliance repair person to fix the refrigerator. Billy may responded simply by saying “yes”, and home robot 130 automatically sends the reservation request to the local refrigerator repair person.

In exemplary embodiments, appliance diagnostic program 120 includes database 129. While database 129 is depicted as being stored on appliance diagnostic program 120, in other embodiments, database 129 may be stored on host server 110, home robot 130, or any other device or database connected via network 102, as a separate database. In alternative embodiments, database 129 may be comprised of a cluster or plurality of computing devices, working together or working separately.

In various embodiments, database 129 may be capable of storing DRs 150 for various IoT home appliances 142, historical data for the number, and type, of malfunctions for each IoT home appliance 142 per year, together with diagnostic reports, repair history, charges, and name of repair person who fixed the IoT home appliance 142. In additional embodiments, database 129 may also store user feedback, usage data, and any other metric, known to one of ordinary skill in the art, that may prove useful in making appliance diagnostic program 120 operate more efficiently and reliably.

In an exemplary embodiment, network 102 is a communication channel capable of transferring data between connected devices and may be a telecommunications network used to facilitate telephone calls between two or more parties comprising a landline network, a wireless network, a closed network, a satellite network, or any combination thereof. In another embodiment, network 102 may be the Internet, representing a worldwide collection of networks and gateways to support communications between devices connected to the Internet. In this other embodiment, network 102 may include, for example, wired, wireless, or fiber optic connections which may be implemented as an intranet network, a local area network (LAN), a wide area network (WAN), or any combination thereof. In further embodiments, network 102 may be a Bluetooth network, a WiFi network, a mesh network, or a combination thereof. In general, network 102 can be any combination of connections and protocols that will support communications between host server 110, home robot 130, home gateway 140, and DR 150.

FIG. 4 is a block diagram depicting components of a computing device (such as host server 110, as shown in FIG. 1), in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Host server 110 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as appliance diagnostic program 120, may be stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Host server 110 may also include a R/W drive or interface 914 to read from and write to one or more portable computer readable storage media 926. Application programs 911 on host server 110 may be stored on one or more of the portable computer readable storage media 926, read via the respective R/W drive or interface 914 and loaded into the respective computer readable storage media 908.

Host server 110 may also include a network adapter or interface 916, such as a TCP/IP adapter card or wireless communication adapter (such as a 4G wireless communication adapter using OFDMA technology). Application programs 911 on host server 110 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Host server 110 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and controlling operation of one or more electronic devices 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications and substitutions can be made without deviating from the scope of the present invention. Therefore, the present invention has been disclosed by way of example and not limitation.

1. A computer-implemented method for diagnosing one or more malfunctions of one or more machines within a network, the method comprising:
monitoring the one or more machines within the network;
identifying one or more machines that is broadcasting a malfunction message;
accessing a product manual for the identified one or more machines;
diagnosing the one or more malfunctions of the identified one or more machines, based on a matching description of the malfunction message within the product manual;
identifying a fixing procedure based on the diagnosed one or more malfunctions; and
communicating the fixing procedure, for the identified one or more machines that is broadcasting the malfunction message, to a user.

2. The computer-implemented method of claim 1, further comprising:
performing a diagnostic data collection on the identified one or more machines that is broadcasting the malfunction message.

3. The computer-implemented method of claim 2, wherein the diagnostic data collection is selected from a group consisting of: vision data collected via a camera, hearing data collected via a microphone, conversation data collected via a speaker, and communication data collected via wireless fidelity (WiFi) networking.

4. The computer-implemented method of claim 2, further comprising:
utilizing an application program interface (API) to perform the diagnostic data collection on the one or more machines that is broadcasting the malfunction message.

5. The computer-implemented method of claim 3, further comprising:
utilizing the microphone and the speaker to interact with the user to collect additional information.

6. The computer-implemented method of claim 1, further comprising:
transmitting a diagnostic report to the user that indicates one or more reasons for the malfunction message of the one or more machines; and
sending a proposed repair form to the user that indicates action required to repair the one or more malfunctions.

7. The computer-implemented method of claim 6, further comprising:
contacting a repair service to repair the one or more malfunctions of the identified one or more machines, based on the diagnostic report and the proposed repair form.

8. A computer program product, comprising a non-transitory tangible storage device having program code embodied therewith, the program code executable by a processor of a computer to perform a method, the method comprising:
monitoring the one or more machines within the network;
identifying one or more machines that is broadcasting a malfunction message;
accessing a product manual for the identified one or more machines;
diagnosing the one or more malfunctions of the identified one or more machines, based on a matching description of the malfunction message within the product manual;
identifying a fixing procedure based on the diagnosed one or more malfunctions; and
communicating the fixing procedure, for the identified one or more machines that is broadcasting the malfunction message, to a user.

9. The computer program product of claim 8, further comprising:
performing a diagnostic data collection on the identified one or more machines that is broadcasting the malfunction message.

10. The computer program product of claim 9, wherein the diagnostic data collection is selected from a group consisting of: vision data collected via a camera, hearing data collected via a microphone, conversation data collected via a speaker, and communication data collected via wireless fidelity (WiFi) networking.

11. The computer program product of claim 9, further comprising:
utilizing an application program interface (API) to perform the diagnostic data collection on the one or more machines that is broadcasting the malfunction message.

12. The computer program product of claim 10, further comprising:
utilizing the microphone and the speaker to interact with the user to collect additional information.

13. The computer program product of claim 8, further comprising:
transmitting a diagnostic report to the user that indicates one or more reasons for the malfunction message of the one or more machines; and
sending a proposed repair form to the user that indicates action required to repair the one or more malfunctions.

14. The computer program product of claim 13, further comprising:
contacting a repair service to repair the one or more malfunctions of the identified one or more machines, based on the diagnostic report and the proposed repair form.

15. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
monitoring the one or more machines within the network;
identifying one or more machines that is broadcasting a malfunction message;
accessing a product manual for the identified one or more machines;
diagnosing the one or more malfunctions of the identified one or more machines, based on a matching description of the malfunction message within the product manual;
identifying a fixing procedure based on the diagnosed one or more malfunctions; and
communicating the fixing procedure, for the identified one or more machines that is broadcasting the malfunction message, to a user.

16. The computer system of claim 15, further comprising:
performing a diagnostic data collection on the identified one or more machines that is broadcasting the malfunction message.

17. The computer system of claim 16, wherein the diagnostic data collection is selected from a group consisting of: vision data collected via a camera, hearing data collected via a microphone, conversation data collected via a speaker, and communication data collected via wireless fidelity (WiFi) networking.

18. The computer system of claim 16, further comprising:
utilizing an application program interface (API) to perform the diagnostic data collection on the one or more machines that is broadcasting the malfunction message.

19. The computer system of claim 17, further comprising:
utilizing the microphone and the speaker to interact with the user to collect additional information.

20. The computer system of claim 15, further comprising:
transmitting a diagnostic report to the user that indicates one or more reasons for the malfunction message of the one or more machines; and
sending a proposed repair form to the user that indicates action required to repair the one or more malfunctions.
